(19) United States
(12) Patent Application Publication
(10) Pub. No.: US 2016/0225122 A1
(43) Pub. Date: Aug. 4, 2016

(54) OPTIMIZING THE VISUAL QUALITY OF MEDIA CONTENT BASED ON USER PERCEPTION OF THE MEDIA CONTENT

(71) Applicants: Joshua BOELTER, Portland, OR (US); Mark YARVIS, Portland, OR (US); Hong LI, El Dorado Hills, CA (US); Sharad GARG, Portland, OR (US); William LEWIS, North Plains, OR (US)

(72) Inventors: Joshua BOELTER, Portland, OR (US); Mark YARVIS, Portland, OR (US); Hong LI, El Dorado Hills, CA (US); Sharad GARG, Portland, OR (US); William LEWIS, North Plains, OR (US)

(21) Appl. No.: 14/368,876

(22) PCT Filed: Dec. 2, 2013
(86) PCT No.: PCT/US2013/072590

§ 371 Date: Jun. 26, 2014

(51) Int. Cl. G06T 3/00; G06F 3/0485; G06F 3/01

(52) U.S. Cl. CPC G06T 3/0012; G06F 3/013; G06F 3/0485; G06T 2210/36; G06T 2200/24

(57) ABSTRACT

Systems and methods may provide for identifying media content and determining a user perception level of the media content. Systems and methods may also provide for reducing a visual quality of at least a portion of the media content for which the user perception level is at least partially limited to optimize resource consumption. One example prevents retrieval of at least a portion of the media content for which the user perception level is completely limited.

### TECHNICAL FIELD

Embodiments generally relate to the display of visual media. More particularly, embodiments relate to optimizing the visual quality of media content based on user perception of the media content.

### BACKGROUND

Visual media may be viewed on a wide variety of devices such as computer displays, handheld devices, media players, and so forth. Conventional approaches to displaying media content may involve retrieving content that is not actually perceived by the user. For example, streaming a video to the display of a handheld device may traditionally include retrieving the video from a remote location even though the video may be viewed from a considerable distance, reduced in size, scrolled off of the screen and/or not the focus of attention. As a result, networking bandwidth and/or power consumption may be negatively impacted without providing any perceived benefit to the user.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a media content viewing session according to an embodiment;

FIG. 2 is a plot of an example of a relationship between user perception and visual quality according to an embodiment;

FIGS. 3A-3D are illustrations of examples of media content viewing sessions having limited user perception according to embodiments;

FIG. 4 is a flowchart of an example of a method of presenting media content according to an embodiment;

FIG. 5 is a block diagram of an example of a logic architecture according to an embodiment;

FIG. 6 is a block diagram of an example of a processor according to an embodiment; and

FIG. 7 is a block diagram of an example of a system according to an embodiment.

### DESCRIPTION OF EMBODIMENTS

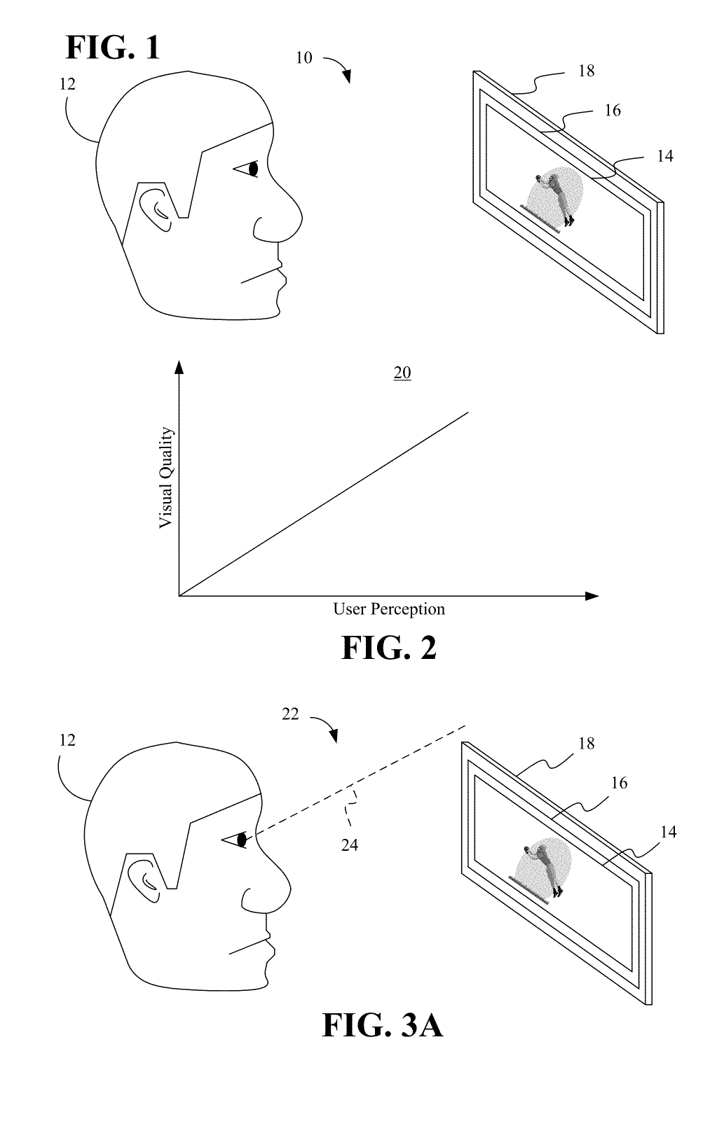

Turning now to FIG. 1, a media content viewing session 10 is shown in which a user 12 observes media content 14 being presented on a display 16 of a device 18 such as, for example, a handheld device (e.g., media player, personal digital assistant/PDA, smart phone, tablet computer, convertible tablet, etc.), notebook computer, desktop computer, workstation, television, stand-alone display, and so forth. In the illustrated example, the media content 14 is fully perceived by the user 12. Accordingly, the illustrated media content 14 is retrieved and encoded for display using normal quality settings.

As will be discussed in greater detail, if it is determined that some or all of the media content 14 is not perceived by the user 12, the device 18 may automatically reduce (e.g., degrade) the visual quality of the media content 14 or discontinue retrieval of the media content 14 (or portions thereof) altogether, depending upon the circumstances. Reducing the visual quality and/or discontinuing retrieval of the media content as described herein may significantly reduce bandwidth and/or power consumption, and may in turn extend battery life, while having little or no impact on the viewing experience.

FIG. 2 shows a plot 20 of a relationship between user perception of media content and the visual quality of that content. In the illustrated example, visual quality is generally a function of the level of user perception,

Qᵥ=f(Pᵤ) (1)

where Qᵥ is visual quality and Pᵤ is the user perception level. More particularly, as the user perception level increases, the visual quality of the media content may also increase, in the example shown. In addition, if the user perception level drops to zero (e.g., the user is not looking at the media content, the media content has been scrolled off of the screen, the media content is completely occluded by other content and/or windows, etc.), then the visual quality may also be set to zero (e.g., retrieval of the media content may be prevented and/or discontinued) because the user perception is completely limited. Although the illustrated plot 20 is linear, the relationship between user perception and visual quality may also be non-linear (e.g., curve, stepped and/or sawtooth profile).

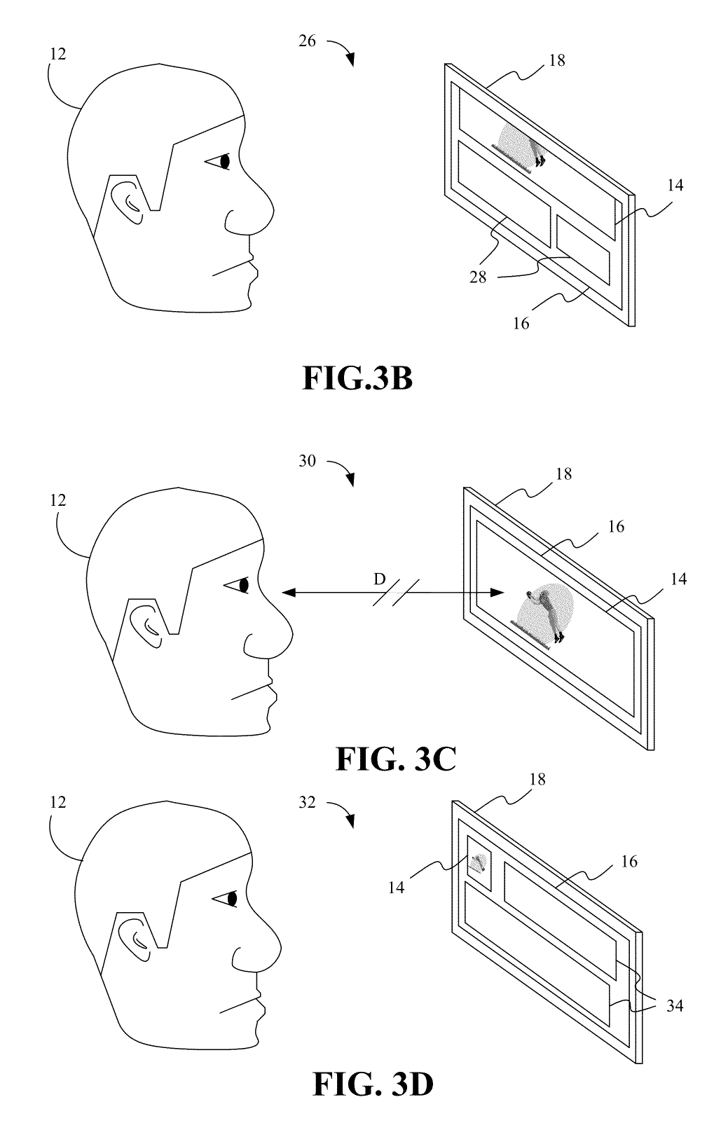

FIG. 3A shows a media content viewing session 22 in which a gaze 24 of the user 12 is directed to a location other than on the media content 14. The gaze 24 may be detected via a front facing camera or other suitable iris detection component of the device 18, wherein the user 12 might be looking away from the device 18 or elsewhere on the display 16. In such a case, it may be determined that the user perception level with respect to the media content 14 is effectively zero (e.g., the user perception is completely limited). As a result, the device 18 may automatically prevent and/or discontinue retrieval of the media content from a remote source (e.g., media server) and/or local memory in order to reduce bandwidth consumption, reduce power consumption and/or extend battery life, without impacting the viewing experience. For example, retrieval of one or more frames corresponding to the time period during which the gaze 24 is not on the media content 14 may be bypassed without the user 12 noticing.

FIG. 3B shows another media content viewing session 26 in which a portion of the media content 14 has been scrolled off of the display window so that other content 28 is also visible to the user 12. In such a case, it may be determined that the user perception level with respect to the portion of the media content 14 that has been scrolled off of the display window (e.g., the “clipped portion”) is effectively zero (e.g., the user perception is completely limited with respect to the clipped portion). As result, the display 18 may prevent and/or discontinue retrieval of the clipped portion of the media content 14 in order to reduce bandwidth consumption, reduce power consumption and/or extend battery life. Preventing retrieval of the clipped portion might involve subdividing one or more frames of the media content 14 into tiles so that the tiles from the clipped portion are not retrieved.

FIG. 3C shows yet another media content viewing session 30 in which the user 12 observes the media content 14 at a considerable physical distance “D” (e.g., from across the room). The physical distance may be determined via presence detection or other suitable sensing technology. The physical distance between the display 18 and the user 12 may therefore be compared to a distance threshold, wherein if the distance threshold is exceeded, it may be determined and/or inferred that the user perception level with respect to the media content 14 is relatively low (e.g., the user perception is partially limited). In such a case, the device 18 may automatically reduce/degrade the visual quality of the media content 14. Such a reduction/degradation may be quantized (e.g., specific levels of degradation between specific distances) or it may be continuous (e.g., a level of degradation that is proportional to distance). As will be discussed in greater detail, reducing the visual quality may involve reducing the bit rate of the media content 14, increasing quantization of the media content 14, selecting a less robust and/or effective encoding scheme for the media content 14, and so forth, while the user 12 is far away from the media content 14. Because the illustrated physical distance is relatively large, the likelihood of the user 12 perceiving the reduced visual quality may be relatively low.

FIG. 3D shows another media content viewing session 32 in which the visual size of the media content 14 has been reduced (e.g., shrank, zoomed out, etc.) so that other content 34 is also visible to the user 12. The visual size of the media content 14 may be determined via window sizing or other appropriate content zooming technologies. The visual size of the media content 14 may be compared to a size threshold (e.g., pixel width/height, screen percentage, etc.), wherein if the size threshold is not exceeded, it may be determined and/or inferred that the user perception level with respect to the media content 14 is relatively low (e.g., the user perception is partially limited). In such a case, the device 18 may automatically reduce the visual quality of the media content 14 (e.g., via bit rate, quantization, encoding scheme, etc.) while the media content 14 is in the reduced size state. Again, the reduction/degradation may be quantized (e.g., specific levels of degradation between specific sizes) or it may be continuous (e.g., a level of degradation that is proportional to size). Because the illustrated visual size is relatively small, the likelihood of the user 12 perceiving the reduced visual quality may be relatively low (e.g., the user perception is partially limited). Other conditions such as, for example, the media content 14 being occluded by a semi-transparent window may also lead to the user perception of the media content 14 being partially limited. Moreover, other techniques to optimizing the visual quality of the media content 14 based on the user perception of the media content 14 may also be used.

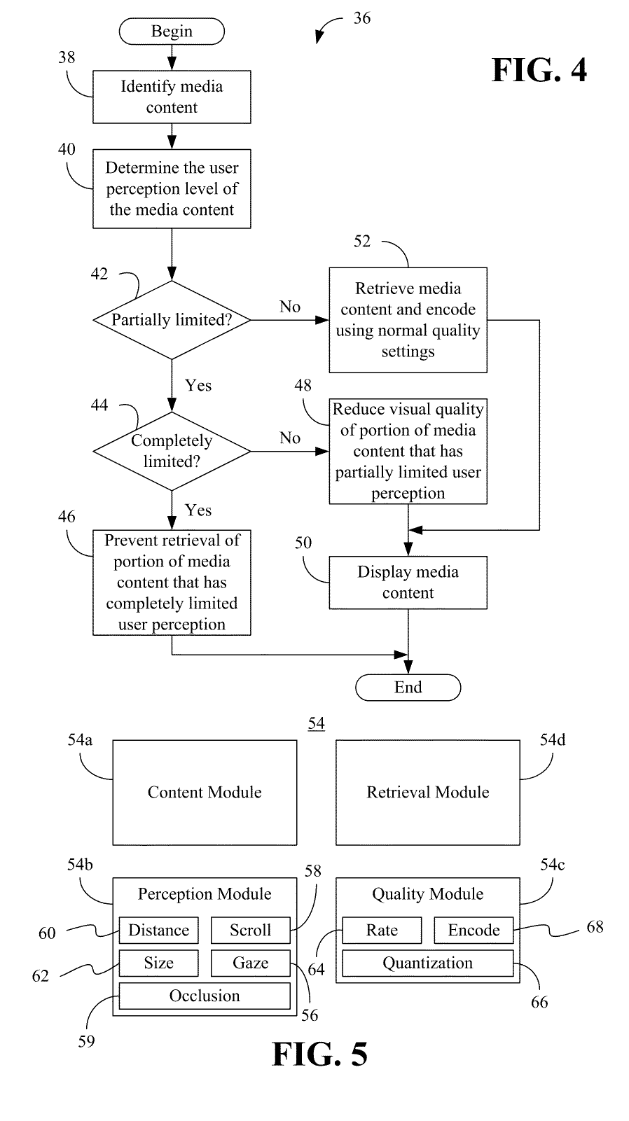

Turning now to FIG. 4, a method 36 of presenting media content is shown. The method 36 may be implemented as a set of logic instructions stored in a machine- or computer-readable storage medium such as random access memory (RAM), read only memory (ROM), programmable ROM (PROM), firmware, flash memory, disk, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof For example, computer program code to carry out operations shown in method 36 may be written in any combination of one or more programming languages, including an object oriented programming language such as Java, Smalltalk, C++ or the like and conventional procedural programming languages, such as the “C” programming language or similar programming languages.

Illustrated processing block 38 provides for identifying media content such as, for example, video, still images, audio, etc., or any combination thereof, wherein the media content 38 may be streamed from a remote source connected to the Internet or from a local server connected to a home network, retrieved from a local source (e.g., flash memory, optical disk, hard disk drive, solid state disk/SSD), etc., and identified by metadata, source, content type, etc., or any combination thereof A determination may be made at block 40 as to the user perception level of the media content. Determining the user perception level may involve, for example, tracking/identifying the gaze location of the user, tracking/identifying the scroll position of the media content within a display window, determining the transparency of other windows occluding the media content, comparing the physical distance between the display presenting the media content and the user, comparing the visual size of the media content to a size threshold, and so forth.

Additionally, a determination may be made at block 42 as to whether the user perception level is at least partially limited for at least a portion of the media content. As already noted, partial limits on the user perception may result from the level of eye gazing, a relatively large viewing distance, relatively small media content, occlusion of the media content by a semi-transparent window, and so forth. If so, illustrated block 44 determines whether the user perception level is completely limited for at least a portion of the media content. As already noted, complete limits on the user perception might result from user distraction, particular facial expressions (e.g., user squinting), portions of the media content being scrolled off of the screen and/or occluded by other non-transparent windows, and so forth.

If the user perception level is completely limited, block 46 may prevent retrieval of the portion of the media content that has completely limited user perception. Thus, block 46 might prevent retrieval of one or more entire frames of the media content if, for example, the gaze of the user is not located on the media content. Block 46 may also involve preventing retrieval of one or more frame tiles corresponding to a clipped portion of the media content if, for example, the clipped portion has been scrolled off of a display window presenting the media content. Moreover, preventing the retrieval may involve withholding one or more content requests (e.g., web requests) to a remote server, instructing a remote server to discontinue delivery of the media content, discontinuing retrieval of the media content from local memory, etc., or any combination thereof. Other techniques may also be used to prevent and/or discontinue retrieval of the media content.

If it is determined at block 44 that the user perception level is not completely limited for at least a portion of the media content, illustrated block 48 reduces and/or degrades the visual quality of the portion of the media content that has partially limited user perception. Thus, block 48 might involve reducing the bit rate of the media content, increasing the quantization of the media content, selecting a less robust encoding scheme for the media content (e.g., eliminating transmission of unnecessary P-frames or B-frames, cropping I-frames, etc.). Selecting the encoding scheme may also involve switching and/or reprogramming media codecs. The reduction of visual quality may be conducted for one or more entire frames of the media content or on a frame tile basis, depending upon the circumstances. Block 50 may provide for displaying the media content as retrieved and encoded. If it is determined at block 42 that the user perception level is not partially limited for at least a portion of the media content, illustrated block 52 retrieves the media content and encodes it using normal quality settings, wherein the media content as retrieved and encoded may be displayed at block 50.

Turning now to FIG. 5, a logic architecture 54 (54a-54d) that presents media content is shown. The illustrated architecture 54, which may implement one or more aspects of the method 36 (FIG. 4) in a device such as, for example, the device 18 (FIGS. 3A-3D), may generally optimize the visual quality of media content based on user perception of the media content. Portions of the architecture 54 may also be implemented in a remote server (not shown) that provides the media content and/or another network component/device. More particularly, a content module 54a may identify the media content, wherein a perception module 54b may determine a user perception level of the media content.

For example, the perception module 54b might include a gaze component 56 that identifies a gaze location of the user (e.g., via an iris detector), a scroll component 58 that identifies a scroll position of the media content within a display window and/or an occlusion component 59 that identifies one or more of a rendered portion or an unrendered portion of the media content. The occlusion component 59 may therefore be useful in determining how much of the media content has been occluded by other windows (e.g., rendered portion) and how much of the media content has not been occluded by other windows (e.g., unrendered portion).

Additionally, the illustrated perception module 54b includes a distance component 60 to determine the physical distance between the display presenting the media content and the user, and compare the physical distance to a distance threshold. The perception module 54b may also include a size component 62 to determine the visual size of the media content and compare the visual size to a size threshold. The perception module 54b may therefore determine whether the user perception level of at least a portion of the media content is either partially or completely limited. In addition to the example components included in the illustrated perception module 54b of FIG. 5, there may be other ways to determine the user perception level that may be utilized for the system and methods.

The illustrated architecture 54 also includes a quality module 54c to reduce/degrade the visual quality of the portion of the media content for which the user perception level is at least partially limited. For example, the quality module 54c may include a rate component 64 to reduce the bit rate of the media content, a quantization component 66 to increase the quantization of the media content, an encode component to select an encoding scheme for the media content, and so forth, wherein the visual quality reduction may be conducted for one or more entire frames and/or one or more frame tiles. The architecture 54 may also include a retrieval module 54d to prevent retrieval of at least a portion of the media content for which the user perception level is completely limited.

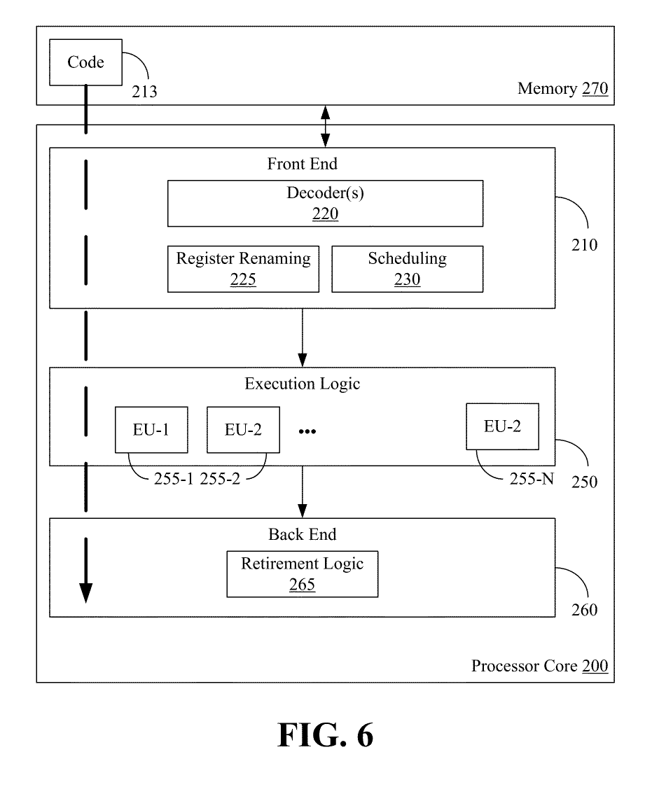

FIG. 6 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 6, a processing element may alternatively include more than one of the processor core 200 illustrated in FIG. 6. The processor core 200 may be a single-threaded core or, for at least one embodiment, the processor core 200 may be multithreaded in that it may include more than one hardware thread context (or “logical processor”) per core.

FIG. 6 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the method 36 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 6, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

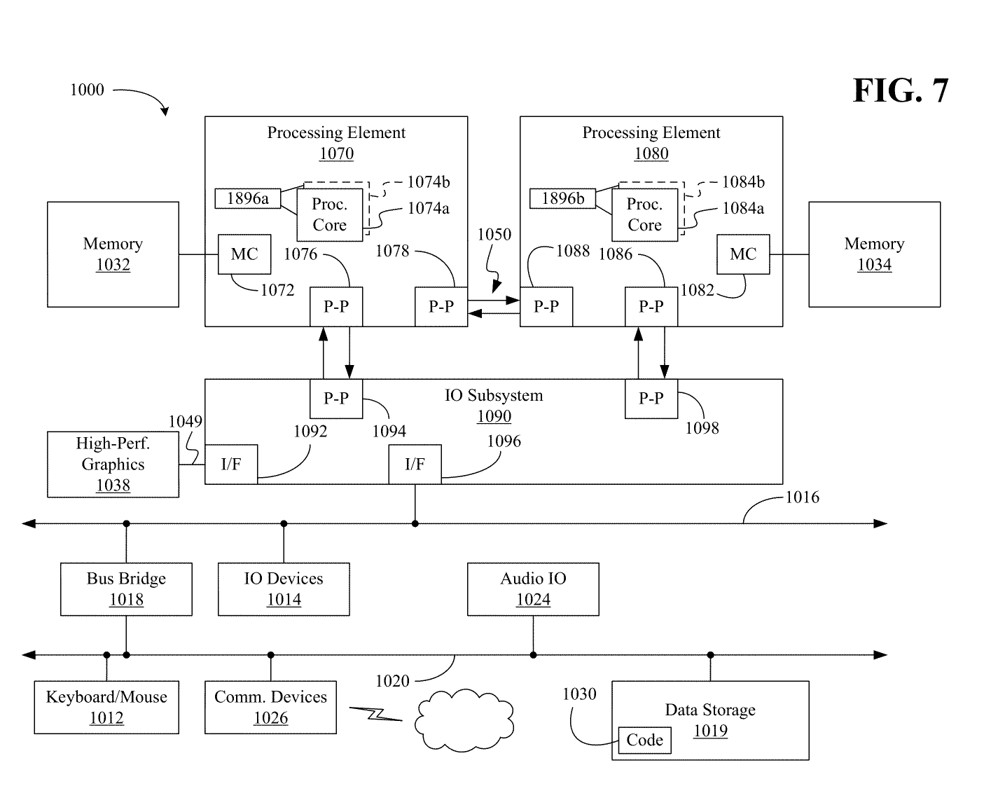

Referring now to FIG. 7, shown is a block diagram of a system 1000 embodiment in accordance with an embodiment. Shown in FIG. 7 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 7, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 7, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 7, various I/O devices 1014 (e.g., cameras) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method 36 (FIG. 4), already discussed, and may be similar to the code 213 (FIG. 6), already discussed. Further, an audio I/O 1024 may be coupled to second bus 1020.

Note that other embodiments are contemplated. For example, instead of the point-to-point architecture of FIG. 7, a system may implement a multi-drop bus or another such communication topology. Also, the elements of FIG. 7 may alternatively be partitioned using more or fewer integrated chips than shown in FIG. 7.

### Additional Notes and Examples

Example 1 may include an apparatus to present media content, comprising a content module to identify media content, a perception module to determine a user perception level of the media content and a quality module to reduce a visual quality of at least a portion of the media content for which the user perception level is at least partially limited. The quality module may include one or more of a rate component to reduce a bit rate of at least a portion of the media content, a quantization component to increase a quantization of at least a portion of the media content or an encode component to select an encoding scheme for at least a portion of the media content. The apparatus may also include a retrieval module to prevent retrieval of at least a portion of the media content for which the user perception level is completely limited.

Example 2 may include the apparatus of Example 1, wherein the perception module includes one or more of a gaze component to identify a gaze location of a user, a scroll component to identify a scroll position of the media content within a display window or an occlusion component to identify one or more of a rendered portion or an unrendered portion of the media content.

Example 3 may include the apparatus of Example 1, wherein the perception module includes a distance component to determine a physical distance between a display presenting the media content and a user.

Example 4 may include the apparatus of Example 1, wherein the perception module includes a size component to determine a visual size of the media content.

Example 5 may include a method of presenting media content, comprising identifying the media content, determining a user perception level of the media content and reducing a visual quality of at least a portion of the media content for which the user perception level is at least partially limited.

Example 6 may include the method of Example 5, further including preventing retrieval of at least a portion of the media content for which the user perception level is completely limited.

Example 7 may include the method of Example 5, wherein determining the user perception level includes identifying a gaze location of a user.

Example 8 may include the method of Example 5, wherein determining the user perception level includes identifying one or more of a scroll position of the media content within a display window, a rendered portion of the media content or an unrendered portion of the media content.

Example 9 may include the method of any one of Examples 5 to 8, wherein determining the user perception level includes determining a physical distance between a display presenting the media content and a user.

Example 10 may include the method of any one of Examples 5 to 8, wherein determining the user perception level includes determining a visual size of the media content.

Example 11 may include the method of any one of Examples 5 to 8, wherein reducing the visual quality includes one or more of reducing a bit rate of at least a portion of the media content, increasing a quantization of at least a portion of the media content or selecting an encoding scheme for at least a portion of the media content.

Example 12 may include at least one computer readable storage medium comprising a set of instructions which, if executed by a computing device, cause the computing device to identify media content, determine a user perception level of the media content and reduce a visual quality of at least a portion of the media content for which the user perception level is at least partially limited.

Example 13 may include the at least one computer readable storage medium of Example 12, wherein the instructions, if executed, cause a computing device to prevent retrieval of at least a portion of the media content for which the user perception level is completely limited.

Example 14 may include the at least one computer readable storage medium of Example 12, wherein the instructions, if executed, cause a computing device to identify a gaze location of a user to determine the user perception level.

Example 15 may include the at least one computer readable storage medium of Example 12, wherein the instructions, if executed, cause a computing device to identify one or more of a scroll position of the media content within a display window, a rendered portion of the media content or an unrendered portion of the media content to determine the user perception level.

Example 16 may include the at least one computer readable storage medium of any one of Examples 12 to 15, wherein the instructions, if executed, cause a computing device to determine a physical distance between a display presenting the media content and a user to determine the user perception level.

Example 17 may include the at least one computer readable storage medium of any one of Examples 12 to 15, wherein the instructions, if executed, cause a computing device to determine a visual size of the media content to determine the user perception level.

Example 18 may include the at least one computer readable storage medium of any one of Examples 12 to 15, wherein the instructions, if executed, cause a computing device to conduct one or more of the following to reduce the visual quality, reduce a bit rate of at least a portion of the media content, increase a quantization of at least a portion of the media content, or select an encoding scheme for at least a portion of the media content.

Example 19 may include an apparatus to present media content, comprising a content module to identify media content, a perception module to determine a user perception level of the media content and a quality module to reduce a visual quality of at least a portion of the media content for which the user perception level is at least partially limited.

Example 20 may include the apparatus of Example 19, further including a retrieval module to prevent retrieval of at least a portion of the media content for which the user perception level is completely limited.

Example 21 may include the apparatus of Example 19, wherein the perception module includes a gaze component to identify a gaze location of a user.

Example 22 may include the apparatus of Example 19, wherein the perception module includes one or more of a scroll component to identify a scroll position of the media content within a display window or an occlusion component to identify one or more of a rendered portion or an unrendered portion of the media content.

Example 23 may include the apparatus of any one of Examples 19 to 22, wherein the perception module includes a distance component to determine a physical distance between a display presenting the media content and a user.

Example 24 may include the apparatus of any one of Examples 19 to 22, wherein the perception module includes a size component to determine a visual size of the media content.

Example 25 may include the apparatus of any one of Examples 19 to 22, wherein the quality module includes one or more of a rate component to reduce a bit rate of at least a portion of the media content, a quantization component to increase a quantization of at least a portion of the media content, or an encode component to select an encoding scheme for at least a portion of the media content.

Example 26 may include an apparatus to present media content, comprising means for performing the method of any one of Examples 5 to 11.

Thus, techniques described herein may selectively retrieve only the content that is perceived by a user by changing media encoding methods and/or imperceptibly degrading quality. As a result, bandwidth consumption and power consumption may be reduced, and responsiveness may be increased.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. An apparatus to present media content, comprising:
a content module to identify media content;
a perception module to determine a user perception level of the media content;
a quality module to reduce a visual quality of at least a portion of the media content for which the user perception level is at least partially limited, wherein the quality module includes one or more of:
a rate component to reduce a bit rate of at least a portion of the media content,
a quantization component to increase a quantization of at least a portion of the media content, or
an encode component to select an encoding scheme for at least a portion of the media content; and
a retrieval module to prevent retrieval of at least a portion of the media content for which the user perception level is completely limited.

27. The apparatus of claim 26, wherein the perception module includes one or more of a gaze component to identify a gaze location of a user, a scroll component to identify a scroll position of the media content within a display window or an occlusion component to identify one or more of a rendered portion or an unrendered portion of the media content.

28. The apparatus of claim 26, wherein the perception module includes a distance component to determine a physical distance between a display presenting the media content and a user.

29. The apparatus of claim 26, wherein the perception module includes a size component to determine a visual size of the media content.

30. A method of presenting media content, comprising:
identifying the media content;
determining a user perception level of the media content; and
reducing a visual quality of at least a portion of the media content for which the user perception level is at least partially limited.

31. The method of claim 30, further including preventing retrieval of at least a portion of the media content for which the user perception level is completely limited.

32. The method of claim 30, wherein determining the user perception level includes identifying a gaze location of a user.

33. The method of claim 30, wherein determining the user perception level includes identifying one or more of a scroll position of the media content within a display window, a rendered portion of the media content or an unrendered portion of the media content.

34. The method of claim 30, wherein determining the user perception level includes determining a physical distance between a display presenting the media content and a user.

35. The method of claim 30, wherein determining the user perception level includes determining a visual size of the media content.

36. The method of claim 30, wherein reducing the visual quality includes one or more of reducing a bit rate of at least a portion of the media content, increasing a quantization of at least a portion of the media content or selecting an encoding scheme for at least a portion of the media content.

37. At least one computer readable storage medium comprising a set of instructions which, if executed by a computing device, cause the computing device to:
identify media content;
determine a user perception level of the media content; and
reduce a visual quality of at least a portion of the media content for which the user perception level is at least partially limited.

38. The at least one computer readable storage medium of claim 37, wherein the instructions, if executed, cause a computing device to prevent retrieval of at least a portion of the media content for which the user perception level is completely limited.

39. The at least one computer readable storage medium of claim 37, wherein the instructions, if executed, cause a computing device to identify a gaze location of a user to determine the user perception level.

40. The at least one computer readable storage medium of claim 37, wherein the instructions, if executed, cause a computing device to identify one or more of a scroll position of the media content within a display window, a rendered portion of the media content or an unrendered portion of the media content to determine the user perception level.

41. The at least one computer readable storage medium of claim 37, wherein the instructions, if executed, cause a computing device to determine a physical distance between a display presenting the media content and a user to determine the user perception level.

42. The at least one computer readable storage medium of claim 37, wherein the instructions, if executed, cause a computing device to determine a visual size of the media content to determine the user perception level.

43. The at least one computer readable storage medium of claim 37, wherein the instructions, if executed, cause a computing device to conduct one or more of the following to reduce the visual quality:
reduce a bit rate of at least a portion of the media content;
increase a quantization of at least a portion of the media content; or
select an encoding scheme for at least a portion of the media content.

44. An apparatus to present media content, comprising:
a content module to identify media content;
a perception module to determine a user perception level of the media content; and
a quality module to reduce a visual quality of at least a portion of the media content for which the user perception level is at least partially limited.

45. The apparatus of claim 44, further including a retrieval module to prevent retrieval of at least a portion of the media content for which the user perception level is completely limited.

46. The apparatus of claim 44, wherein the perception module includes a gaze component to identify a gaze location of a user.

47. The apparatus of claim 44, wherein the perception module includes one or more of a scroll component to identify a scroll position of the media content within a display window or an occlusion component to identify one or more of a rendered portion or an unrendered portion of the media content.

48. The apparatus of claim 44, wherein the perception module includes a distance component to determine a physical distance between a display presenting the media content and a user.

49. The apparatus of claim 44, wherein the perception module includes a size component to determine a visual size of the media content.

50. The apparatus of claim 44, wherein the quality module includes one or more of:
a rate component to reduce a bit rate of at least a portion of the media content;
a quantization component to increase a quantization of at least a portion of the media content; or
an encode component to select an encoding scheme for at least a portion of the media content.
